(19) United States
(12) Patent Application Publication
(10) Pub. No.: US 2003/0177056 A1
(43) Pub. Date: Sep. 18, 2003

(54) Method for valuating a business opportunity

(76) Inventor: Kaspar Tobias Winther, Upton, MA (US)

Correspondence Address: Kaspar Tobias Winther, 7 Walnut Street, Upton, MA, 01568-1101, US

(21) Appl. No.: 10/097,465

(22) Filed: Mar. 13, 2002

(51) Int. Cl. G06F 17/60

(52) U.S. Cl. 705/10

(57) ABSTRACT

A method to valuating a business opportunity is presented. It takes a starting point in the value to the customer or the buyer and how this value relates to the configuration of the value net. The value is discounted based on the risk for the buyer. The relative market power between seller and buyer is established as a measure for how much of this discounted value the seller will at most be in a position to charge thereby obtaining the maximum market price. The cost to the seller is established and subtracted it from the maximum market price to obtain the possible profit. By analyzing the changes in all of these parameters as the market changes in size the optimal pricing strategy can be found. By analyzing the impact of different value net configurations different business strategies can be evaluated.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM

Not Applicable.

### BACKGROUND OF THE INVENTION

Key decisions determining the financial success of a business are often based on historical trends combined with professional opinions about the future market. Such commonplace methods as the Discounted Cash Flow Method, used in calculating the Net Present Value of a business opportunity, is traditionally based on estimated future cash flows obtained in this manner. For products and companies that have an established track record, the estimates can be fairly accurate, however, for new products and startup companies this method cannot be used, as there are no relevant historical trends. The uncertainty introduced by not having adequately accurate estimates can have catastrophic consequences and it increases the overall risk and thereby the cost of capital. It is particularly under those circumstances that the method presented in this patent can provide significant value added. The method facilitates independent estimates of future cash flows.

### BRIEF SUMMARY OF THE INVENTION

The method presented herein provides a set of tools that can be utilized in analyzing future opportunities and use historical data from different business areas as a basis for a more rigorous and systematic estimate of future cash flows. The method starts by identifying the value to the buyer. This value is then discounted according to the risk to the buyer. The relative market power between the buyer and the seller is then estimated to find how much of this discounted value to the buyer the seller actually will be in a position to charge. This gives an estimate of the highest possible market price. By subtracting the cost to the seller the feasible profit margin is identified. When this is done across the market the overall future cash flows can be estimated.

### BRIEF DESCRIPTION OF THE DRAWINGS

FIG. 1 illustrates the break down of value and how it leads to an estimate of the profit opportunity

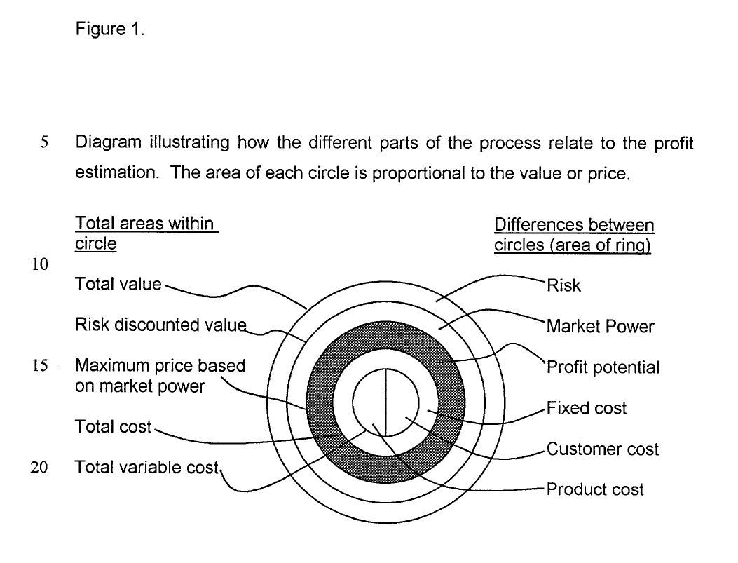

### DETAILED DESCRIPTION OF THE INVENTION

A business opportunity as dealt with in this invention is any transaction that involves the exchange of money or other assets. It can be part of an ongoing business operation, such as the sale of products by a manufacturer, or it may be a one-time transaction where an asset is traded.

Any business activity can be described as taking place in a value net consisting of nodes represented by individuals, businesses and other entities. These nodes interact to create value for each other and for themselves. The value to a given node can be determined by a number of value drivers, a value driver is here defined as a quantifiable contributor to the creation or destruction of value. The value drivers can be calibrated using data from fields other than the case being investigated. The following part of the process focuses on the relationship between a node represented by the seller of a product or service and the node or nodes representing the buyer, buyers or customers. The value to the customers can be estimated by using these value drivers and the influence of factors governed by nodes other than the buyer and the seller can be estimated. Once the value to the buyer has been established their risk associated with the purchase is estimated. This risk can be associated with product failures or inability to meet the customer's needs. The full value is then discounted according to this risk. After that the relative market power between the seller and the buyer is estimated. The fraction of the discounted value that the seller can charge is calculated based on this power. Finally, the cost is estimated and the profit opportunity determined. By applying this process across customers and extending out into the future, future cash flows can be determined and used as a basis for calculating the Net Present Value of a prospective or ongoing business opportunity. Considering that a business consists of multiple of these cash flow streams, the calculations can also be used as a basis for estimating fair stock prices. A preferred embodiment of the method is described in the following:

A. The value net is mapped out in detail. The value net will contain all the entities that are part of the supply chain as well as influence the nodes in the supply chain, for example, entities exerting indirect influence on the consumer will become part of the value net even if they do not participate in any monetary transactions. The role of each node is documented.

B. Value drivers are identified. Value drivers are specific and quantifiable parameters that may have an influence on the value to a given node. They may describe supplies of products or services, complementary products or services, competing product or services, regulations that impose restrictions on the use or sale of these products or services, promotions that influences the perceived values, or any other direct or indirect, positive or negative influence on the value. Depending how they influence the value creating process they can be classified as either relating to the supply, the market interactions or the consumption part of the value creating process. Each value driver relates to one or more nodes in the value net. Quantitative information on value drivers is collected from not only the business or investment opportunity in question, but from other businesses and markets as well. In that way proxies from other fields are used to quantify characteristics of an unknown market or uncertain business opportunity. These proxies can be related to known characteristics of the buyer or buyers in the market, such as demographic profiles. This approach is justified based on the fact that customers will have certain predictable reactions independent of the specific nature of the product or service in question.

C. A mathematical model is developed that relates the value for the customer to all the value drivers. The model can be developed using methods such as multivariate linear regression, partial least squares, support vector machines or neural networks. The input upon which the model is calibrated is a variety of quantifiable parameters such a historical business data, statistics, and consumer surveys. By using these mathematical methods the important value drivers for a given business are separated from the large total number of value drivers. The established model can estimate the value to the buyer, buyers, or customers and changes in this value as specific changes in the value net take place. Based on the known business arrangements, and realities of the value net, a best estimate for the value to the customer can be calculated.

D. Any buyer, buyers or customers will face a risk related to the purchase and possible consumption of any product or service. This risk may be related to product failure, lack of fulfillment of expectations or lack of complementary products. This risk is quantified as a probability that the customer will fail obtaining the desired value from the product or service within the time period of one year. Based on this probability the discounted value is found the same way as the Net Present Value is found based on a discount rate or opportunity cost of capital.

E. The market power between the seller, the buyer and other players in the market such as suppliers of competing or complementary products are established. This market power is a number between zero and one, where one indicates that the seller is in full control, and is in a position to charge the full amount of value to the buyer. Likewise zero indicates that the seller cannot capture any of the value that the buyer will obtain through the transaction. This market power is obtained by analyzing businesses in other areas, and their profit margins. By multiplying the market power factor and the risk discounted value to the buyer the largest feasible market price is estimated, that is the maximum market price.

F. The cost associated with the product or service in question is estimated. In many cases the there will be one cost component representing the fixed cost relating to the development of the technology, manufacturing processes and technology, intellectual property and other investments providing intellectual leverage. There will also be a variable cost component that can be divided into a product specific component, such as parts and materials, and a customer specific component such as customer service and technical support. By subtracting the cost from the largest feasible market price the feasible profit range is established.

G. The steps above are extended to cover a range of different market sizes and the possible customer at each market size. As the value, risk, market power and cost all will change according to the market each market size will be associated with a price and profit pair. The price is established taking the maximum market price into account and the profit calculated according to the above scheme.

H. By investigating likely changes in the market size and the value net configuration over time estimates of future cash flows can be established for several years. Based on the opportunity cost of capital or the discount rate these future cash flows can be discounted to the net present value.

I. Different configurations of the value net can then be evaluated through estimating the impact on the value to the user, and profit oportunities. By repeating steps A through H for each of these alternatives different business strategies can be evaluated.

J. The net present value estimate calculated in “I” for the strategy selected can be used as a basis for estimating the fair market price of a stock of a public listed company or the fair market price of a privately held company. Besides these kinds of investment opportunities, other investment opportunities, such as a proposed project can be valuated in a similar manner. This project could be developing and selling a new product or a new service.

What is claimed is:

1. A method for obtaining a valuation of a business opportunity comprising the following steps:
(a) estimating the value to the buyers
(b) estimating the risk to the buyers and calculating a discounted value to the buyers based on said risk
(c) estimating the market power between seller and buyers, and estimating the maximum market price based on said discounted value and said market power
(d) estimating the cost to the seller
(e) estimating the feasible profit range based on said maximum market price and said cost
whereby a pricing strategy can be selected and the potential financial implications associated with executing said business opportunity can be evaluated.

2. The method of claim 1 in which said valuation pertains to an ongoing business operation.

3. The method of claim 1 in which said valuation pertains to a one-time transaction of an asset.

4. The method of claim 1 in which said valuation pertains to future sales and the estimated future cash flows originating from said sales are discounted to find the net present value.

5. The method of claim 4 in which said valuation is used to estimate the fair market price of a stock.

6. The method of claim 4 in which said valuation is used to estimate the fair market price of a privately held company.

7. The method of claim 1 in which said business opportunity is an investment opportunity.

8. The method of claim 1 in which said valuation pertains to a product.

9. The method of claim 1 in which said valuation pertains to a service.

10. The method of claim 1 in which said value to the buyer is obtained through a process comprising the following steps:
(a) identifying specific value drivers that influence the value as perceived by the buyers
(b) correlating said value drivers with observable parameters pertaining to the buyers and to other nodes in the value net
(c) calibrating a mathematical model based on historical data representing relevant quantifications of said observable parameters
(d) using said mathematical model to estimating the value to the buyer based on the profile of the buyer and the configuration of the value net.

11. The method of claim 1 in which said risk to the buyer is obtained through the analysis of historical data from other business activities.

12. The method of claim 1 in which said market power is estimated through the analysis of historical data from other business activities.

13. The method of claim 1 in which said cost comprises a fixed cost component related to the intellectual leverage and a variable cost that in turn comprises a product specific component and a customer specific component.

14. A method to obtain a valuation of a business opportunity comprising the following steps:
(a) estimating the value to the buyer
(b) estimating the risk to the buyer and calculating a discounted value to the buyer based on said risk
(c) estimating the market power between seller and buyer, and estimating the maximum market price based on said discounted value and said market power
(d) estimating the cost to the seller
(e) estimating the feasible profit range based on said maximum market price and said cost
whereby an optimal price can be selected and the potential financial implications associated with executing said business opportunity can be evaluated.

15. The method of claim 14 in which said valuation pertains to a one time transaction of an asset.

16. A method to obtain a valuation of a business opportunity comprising the following steps:
(a) identifying all important nodes in the value net surrounding said business opportunity
(b) identifying the value drivers that are important to each of said nodes
(c) constructing a mathematical model that relates the total value to each of said nodes to the specific value drivers important to said nodes
(d) using historical data to calibrate said mathematical model
(e) combining the results of said mathematical model with estimates of risk factors and market power to estimate the maximum transaction price associated with said business opportunity
whereby a pricing strategy can be selected and the potential financial implications associated with executing said business opportunity can be evaluated.

17. The method of valuation in claim 16 in which said value drivers relate to value created through production, market interactions and consumption.

18. The method of claim 16 in which said valuation pertains to an ongoing business operation.

19. The method of claim 16 in which said valuation pertains to a one-time transaction of an asset.
